(19) United States
(12) Patent Application Publication
(10) Pub. No.: US 2024/0313970 A1
(43) Pub. Date: Sep. 19, 2024

(54) SPEAK-TO-EARN TOKENS

(71) Applicant: Rakuten Symphony India Pte. Ltd., Indore, MP (IN)

(72) Inventor: Mallikarjunaiah MAHALINGAIAH, Indore (IN)

(21) Appl. No.: 18/245,344

(22) PCT Filed: Dec. 6, 2022
(86) PCT No.: PCT/US2022/052022

§ 371 Date: Mar. 15, 2023

(51) Int. Cl. H04L 9/32; H04L 9/00

(52) U.S. Cl. CPC H04L 9/3213; H04L 9/50; H04L 2209/60; H04L 2209/80

(57) ABSTRACT

Speak-To-Earn Tokens are created. A processor receives a selection of a consensus mechanism for Speak-To-Earn Tokens, wherein the Speak-To-Earn Tokens include a value based on a measurement of speaking using a mobile device in a telecommunication network. The processor receives a selection of a blockchain platform for the Speak-To-Earn Tokens and receives input for designing nodes for the Speak-To-Earn Tokens. The processor establishes a blockchain for the Speak-To-Earn Tokens based on the consensus mechanism, the blockchain platform, and the nodes. The processor generates the Speak-To-Earn Tokens based on the blockchain, and provisions the Speak-To-Earn Tokens for transfer to subscribers of the telecommunication network according to rules defined in the blockchain.

### TECHNICAL FIELD

This description relates to creation of Speak-To-Earn Tokens, and method of creating Speak-To-Earn Tokens.

### BACKGROUND

While initially many were skeptical about digital assets competing with traditional, cryptocurrencies have become increasingly common. Cryptocurrency is a type of digital currency that exists in a blockchain on a server, which encrypts and stores data regarding transactions in blocks. There are many variations of cryptocurrencies. Cryptocurrencies are able to be defined according to how the cryptocurrencies formulation or code design, application or use case, and other factors. Cryptocurrencies are able to take the form of coins, payment tokens or altcoins, security tokens, Non-Fungible Tokens (NFTs), Decentralized Finance (DeFi) tokens, utility tokens, and other categories. Although the term cryptocurrencies are used to define the different types of cryptocurrency or digital currencies, it is commonly interchanged with the term coins. Cryptocurrencies are commonly regarded as coins despite many of them not serving as a unit of account, store of value, and a medium of exchange.

There are also different types of earning crypto tokens in the crypto market. Examples include play-to-earn, learn-to-earn, move-to-earn, steps-to-earn, etc. For example, play-to-earn are associated with games that allow players to receive in-game crypto currency for playing games. Similarly, learn-to-earn rewards users with tokens for learning about a subject, such as cryptocurrencies. Move-to-earn and step-to-earn incentivize players to earn crypto-based rewards by conducting physical activities by participating through a platform. However, there are currently no cryptocurrency or applications for speak-to-earn tokens, where a user earns value by speaking to another user using a telecommunications network.

### SUMMARY

In at least embodiment, a method for creating a Speak-To-Earn Token includes receiving, at a processor, a selection of a consensus mechanism for Speak-To-Earn Tokens, wherein the Speak-To-Earn Tokens include a value based on a measurement of speaking using a mobile device in a telecommunication network, receiving, at the processor, a selection of a blockchain platform for the Speak-To-Earn Tokens, receiving, at the processor, input for designing nodes for the Speak-To-Earn Tokens, establishing, by the processor, a blockchain for the Speak-To-Earn Tokens based on the consensus mechanism, the blockchain platform, and the nodes, generating, by the processor, the Speak-To-Earn Tokens based on the blockchain, and provisioning, by the processor, the Speak-To-Earn Tokens for transfer to subscribers of the telecommunication network according to rules defined in the blockchain.

In at least one embodiment, a system for creating a Speak-To-Earn Token includes a memory storing computer-readable instructions, and a processor connected to the memory, wherein the processor is configured to execute the computer-readable instructions to receive selection of a consensus mechanism for Speak-To-Earn Tokens, wherein the Speak-To-Earn Tokens include a value based on a measurement of speaking using a mobile device in a telecommunication network, receive selection of a blockchain platform for the Speak-To-Earn Tokens, receive input for designing nodes for the Speak-To-Earn Tokens, establish a blockchain for the Speak-To-Earn Tokens based on the consensus mechanism, the blockchain platform, and the nodes, generate the Speak-To-Earn Tokens based on the blockchain, and provision the Speak-To-Earn Tokens for transfer to subscribers of the telecommunication network according to rules defined in the blockchain.

In at least one embodiment, a non-transitory computer-readable media having computer-readable instructions stored thereon, which when executed by a processor causes the processor to perform operations including receiving a selection of a consensus mechanism for Speak-To-Earn Tokens, wherein the Speak-To-Earn Tokens include a value based on a measurement of speaking using a mobile device in a telecommunication network, receiving, at the processor, a selection of a blockchain platform for the Speak-To-Earn Tokens, receiving input for designing nodes for the Speak-To-Earn Tokens, establishing a blockchain for the Speak-To-Earn Tokens based on the consensus mechanism, the blockchain platform, and the nodes, generating the Speak-To-Earn Tokens based on the blockchain, and provisioning the Speak-To-Earn Tokens for transfer to subscribers of the telecommunication network according to rules defined in the blockchain.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 is a diagram of a speak-to-earn system according to at least one embodiment.

FIG. 2 is a mobile phone according to at least one embodiment.

FIG. 3 is a flowchart of a method for creating Speak-To-Earn Tokens according to at least one embodiment.

FIG. 4 is a comparison of consensus mechanism to use for Speak-To-Earn Tokens according to at least one embodiment.

FIG. 5 illustrates NEAR sharding according to at least one embodiment.

FIG. 6 illustrates the operation of a Speak-To-Earn Token System according to at least one embodiment.

FIG. 7 is a high-level functional block diagram of a processor-based speak-to-earn system according to at least one embodiment.

FIG. 8 is a high-level functional block diagram of a processor-based system according to at least one embodiment.

### DETAILED DESCRIPTION

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein likewise are interpreted accordingly.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or data-stream or signaling-stream. The foregoing terms are utilized interchangeably in the subject specification and related drawings. The terms “access point,” “base station,” “Node B,” “evolved Node B (eNode B),” next generation Node B (gNB), enhanced gNB (en-gNB), home Node B (HNB),” “home access point (HAP),” or the like refer to a wireless network component or apparatus that serves and receives data, control, voice, video, sound, gaming, or data-stream or signaling-stream from UE.

In at least embodiment, a method for creating a Speak-To-Earn Token includes receiving, at a processor, a selection of a consensus mechanism for Speak-To-Earn Tokens, wherein the Speak-To-Earn Tokens include a value based on a measurement of speaking using a mobile device by a user to another user in a telecommunication network, receiving, at the processor, a selection of a blockchain platform for the Speak-To-Earn Tokens, receiving, at the processor, input for designing nodes for the Speak-To-Earn Tokens, establishing, by the processor, a blockchain for the Speak-To-Earn Tokens based on the consensus mechanism, the blockchain platform, and the nodes, generating, by the processor, the Speak-To-Earn Tokens based on the blockchain, and provisioning, by the processor, the Speak-To-Earn Tokens for transfer to subscribers of the telecommunication network according to rules defined in the blockchain.

Embodiments described herein provide a method that provides one or more advantages. For example, the Speak-To-Earn Token provides an opportunity significant share in the cryptocurrency market. In response to issuance of 10 billion Speak-To-Earn Tokens in the market, and the value of the Speak-To-Earn Token reaching $1 dollar, then the Speak-To-Earn Token results in a $10 billion dollar market capitalization. In such a large market provided by the telecom industry, the Speak-To-Earn Token is capable of becoming a top 10 cryptocurrency. Also, the Speak-To-Earn Token is able to increase subscribers in the mobile network. Through the Speak-To-Earn Token, the user is also able to receive and use service provider rewards. For example, in response to users recharging their mobile package with Speak-To-Earn Token, then the user is granted an extra 10 GB data for free. Such data reward is capable of being limited to a predetermined number of users, e.g., first 1 million users. Thus, a telecom provider is able to use the Speak-To-Earn Token as a marketing strategy, to attracts subscribers, to incentivize subscribers to use the services of the telecom provider, etc.

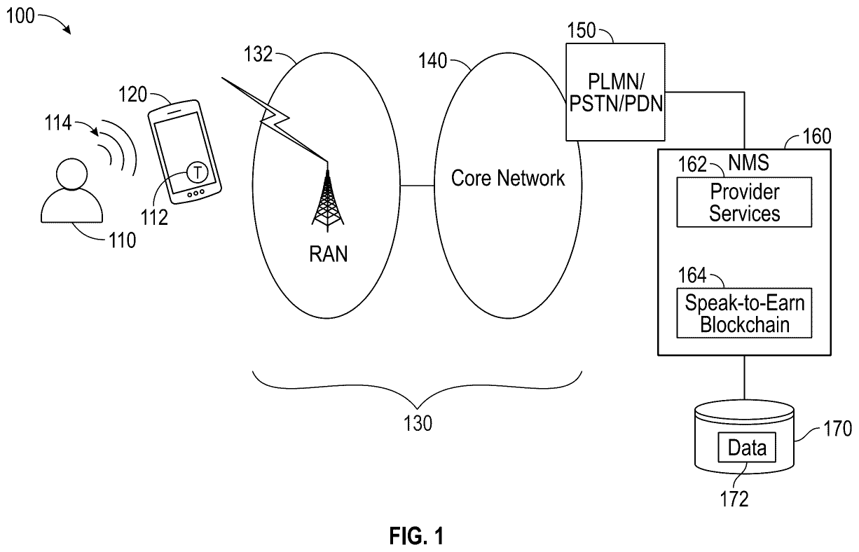

FIG. 1 is a diagram of a speak-to-earn system 100 according to at least one embodiment.

In FIG. 1, User 110 acquires a Speak-To-Earn Token 112 that is stored in a Mobile Phone 120 of the user 110. User 110 uses Mobile Phone 120 to make calls or uses other voice services by Speaking 114 into Mobile Phone 120. Mobile Phone 120 is connected to Mobile Network 130 that includes RAN 132 and Core Network 140.

The Speak-To-Earn Token 112 functions as a multi-utility token instilling economic incentives for the network 130. Moreover, the Speak-To-Earn Token 112 is able to be combined with data credits associated with access to certain aspects of the Network 130 and the rest of the provider ecosystem.

RAN 132 is responsible for managing radio resources, including strategies and algorithms for controlling power, channel allocation and data rate. RANs 132 have evolved over time, from 3G to 5G. For example, RAN 132 is capable of being implemented in various configurations, such as Global System for Mobile Communications (GSM) RAN (GRAN), GSM Enhanced Data Rates for GSM Evolution (EDGE) RAN (GERAN), Universal Mobile Telecommunications Service (UMTS) Terrestrial RAN (UTRAN), Evolved UMTS Terrestrial RAN (E-UTRAN), Centralized/Cloud RAN (CRAN), Virtualized RAN (VRAN), and Open RAN (ORAN).

In a 3G network, RAN 132 includes the base station for cells sites, which is called a Node B (NB), and a Radio Network Controller (RNC). In a 4G network, cell sites are implemented using Evolved Node Bs (eNodeBs or eNBs) for the radio base station. The eNodeBs are able to perform the radio access functions and connect to the Core Network 140. In a 5G network, cell sites are implemented using one of two types of RANs: Next Generation Node B (gNodeB) and Next Generation Evolved Node B (ng-eNB). The ng-eNB is an enhanced version of 4G eNodeB and connects Mobile Phone 120 to a 5G type of Core Network 140 using 4G LTE air interface. The gNB allows Mobile Phone 120 to connect with Core Network 140

Core Network (CN) 140 connects RAN 132 to networks 150, such as a Public Landline Mobile Network (PLMN), a Public Switched Telephone Network (PSTN) and a Packet Data Network (PDN). CN 140 provides high-level traffic aggregation, routing, call control/switching, user authentication and charging.

Network 130 is managed by the Network Management System (NMS) 160, which provides Provider Services 162 associated with network management functionalities. According to at least one embodiment, the NMS monitors network elements in Network 130 and logs data regarding the performance of the network elements. NMS 160 includes tools and applications that support a network manager in monitoring and controlling the network. A network management system can detect, configure, monitor, and troubleshoot network devices, mitigating the need for a lot of manual work. Among other functions fault management, configuration management, administration, performance management, and security management.

Fault management includes the detection of problems, isolation of the problem, determination of what is causing the problem, troubleshooting and resolution of the problem, and documenting the process used to resolve the problem. Configuration management includes monitoring and documenting network and device configurations. Network managers use the NMS 160 to set, maintain, organize, and update configuration information for the network and network devices. Administration includes administering network users with passwords and permissions, backing up software, and performing accounting functions, such as billing. Performance management includes maintaining the efficiency of the network through measurement of metrics, such as throughput, uptime and downtime, error rates, percentage utilization, response time, and latency. Performance events and devices are monitored and changes are tracked. Security management includes the prevention, detection, and responses to prevent security threats.

NMS 160 also generates Speak-To-Earn Token 112 that is provided to Mobile Phone 120 of User 110. NMS 160 also manages and controls a Speak-To-Earn Blockchain 164. Speak-To-Earn Blockchain 164 includes a list of records, called blocks, that are securely linked together using cryptography. Each block in Speak-To-Earn Blockchain 164 includes a cryptographic hash of the previous block, a timestamp, and transaction data. The timestamp proves that the transaction data existed when the block was created. Since each block in Speak-To-Earn Blockchain 164 includes information about the previous block, the blocks effectively form a chain, with each additional block linking to the ones before it. Consequently, transactions involving Speak-To-Earn Blockchain 164 are irreversible in that, once they are recorded, the data in any given block cannot be altered retroactively without altering subsequent blocks.

Storage 170 is used to store Data 172. Data 172 includes subscriber records of User 110 and other information associated with provisioning of Provider Services 162. Data 172 also includes immutable ledger of records associated with Speak-To-Earn Token 112, such as time of use of Network 130, determination of value associated with Speak-To-Earn Token 112, determination of rewards or other incentives for using Network 130 and Speak-To-Earn Token 112, etc.

Speak-To-Earn Token 112 is based on Speak-To-Earn Blockchain 164. A blockchain is a type of distributed ledger technology (DLT) that includes a growing list of records, called blocks, that are securely linked together using cryptography. Blocks contain a cryptographic hash of the previous block, a timestamp, and transaction data. Since each block contains information about the previous block, the blocks effectively form a chain, with each additional block linking to the block before. Consequently, transactions using Speak-To-Earn Blockchain 164 are irreversible in that, once they are recorded, the data in any given block cannot be altered retroactively without altering subsequent blocks.

Speak-To-Earn Token 112 is the digital representation of a particular asset or utility in Speak-To-Earn Blockchain 164. Speak-To-Earn Token 112 is coded to facilitate smart contracts on Speak-To-Earn Blockchain 164. Speak-To-Earn Token 112 are embedded in self-executing computer programs or codes. Speak-To-Earn Token 112 is also fungible and tradable. Speak-To-Earn Token 112 is able to be used to represent loyalty points, commodities, rewards, etc.

The telecommunications provider is the only creator and supplier of the Speak-To-Earn Token 112. In the telecommunications industry, there are no specific cryptocurrencies for leveraging the network 130 of telecommunications provider. User 110 is able to use the Speak-To-Earn Token 112 to earn value. Because of the widespread use of mobile phones, a large number of Speak-To-Earn Tokens 112 are likely to be used, e.g., hundreds of millions to tens of billions. Accordingly, the market capitalization of ten billion is possible with ten billion tokens reaching a value of one dollar.

The Speak-To-Earn Token 112 is able to be used for subscriber packages, rewards, data plans, etc. Users 110 (e.g., subscribers) are able to use the Speak-To-Earn Token 112 for each of their mobile phones.

In telecommunications network 130, there are incoming calls and outgoing calls. Every subscriber has an identifier and the Mobile Phones 120 include other identifiers. For example, IMSI (International Mobile Subscriber Identity) is a unique number associated with a SIM card. IMSI doesn't change, even in response to a user swapping a SIM card into a different phone. IMEI (International Mobile Equipment Identity) is a unique number identifying a particular phone. The IMEI changes whenever a different phone is used. ESN (Equipment Serial Number) uniquely identifies equipment and is embedded electronically by the manufacturer. Mobile Subscriber ID (MSID) (also referred to as Mobile Identification Number (MIN)) is a number to identify mobile subscribers within a mobile carrier network. The MSIN is part of the International Mobile Subscriber Identity (IMSI) number. These identifiers allow User 110 to be identified within a network 130 by the telecom provider at NMS 160.

In the Speak-To-Earn Blockchain network 164, these identifiers are able to be tracked and used to determine the type and amount of usage of the network 130. Based on the calculation of the amount of speaking, the Speak-To-Earn Token 112 is available as a reward to User 110 in an application running on the Mobile Phone 120. User 110 is able to use the Speak-To-Earn Token 112 or is able to sell the Speak-To-Earn Token 112 in the marketplace. The value of the Speak-To-Earn Token 112 is controlled from the backend of the network 130, e.g., at NMS 160. The value of the Speak-To-Earn Token 112 is based on a smart contract associated with Speak-To-Earn Blockchain 164 that the telecom provider references to generate the Speak-To-Earn Token 112.

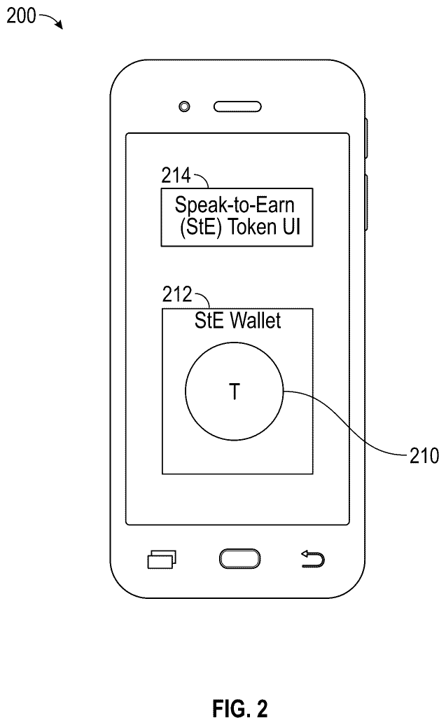

FIG. 2 is a Mobile Phone 200 according to at least one embodiment.

In FIG. 2, Mobile Phone 200 stores a Speak-To-Earn Token 210. Speak-To-Earn Token 210 is stored in a Speak-To-Earn Token Wallet 212 on Mobile Phone 200. Mobile Phone 200 is capable of being implemented as any type of telecommunication device that uses a telecommunication network for voice services, including smart phones, tablets having built-in cellular capability, cellular Internet-of-Things (IoT) devices, Web3 phones, etc. Web3 is a developing technology that uses blockchains, cryptocurrencies, and NFTs to provide users ownership of digital assets and also supports native payments for spending and sending money online instead of relying on the outdated infrastructure of banks and payment processors. Once Web3 mobile phones become available with crypto clients, the opportunity for leveraging the technology will become available for companies, including telecommunication providers.

Speak-To-Earn Token Wallet 212 stores the public and/or private keys for transactions using Speak-To-Earn Token 210. In addition to this basic function of storing the keys, a Speak-To-Earn Token Wallet 212 is also able to encrypt and/or sign information. Signing, for example, results in executing a smart contract associated with the Speak-To-Earn Token 210, a transaction image or identification associated with Speak-To-Earn Token 210, and/or a legal signature.

Speak-To-Earn Token User Interface 214 integrates Speak-To-Earn Token 210 and services into Speak-To-Earn Token User Interface 214 at the application layer. Transactions associated with use of Speak-To-Earn Token 210 are constructed by Speak-To-Earn Token User Interface 214, signed by Speak-To-Earn Token Wallet 212, and recorded by Speak-To-Earn Token Blockchain networks. In addition to user account data, distributed file storage systems are capable of hosting Speak-To-Earn Token User Interface 214 so that Mobile Phone 200 includes an application for presenting Speak-To-Earn Token User Interface 214 based on information provided by the provider.

The design of the Speak-To-Earn Token User Interface 214 is based on the backend of the network. Based on the consensus and blockchain platform, and design nodes, the Speak-To-Earn provider, e.g. a telecom provider, connects with Mobile Phone 200 via Speak-To-Earn Token User Interface 214 and determines the value to give to the Speak-To-Earn Token 210 of a subscriber based on a smart contract.

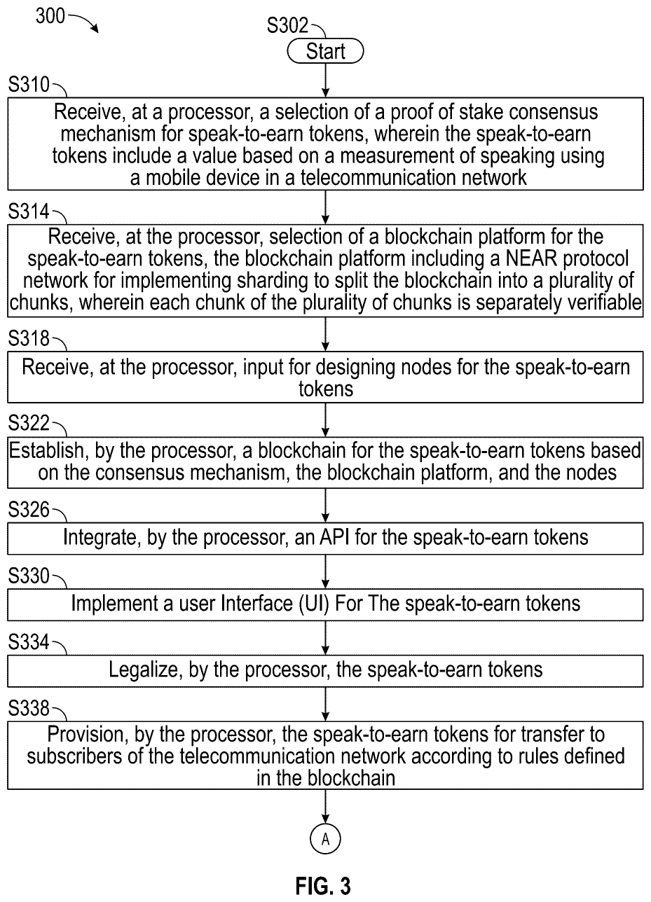

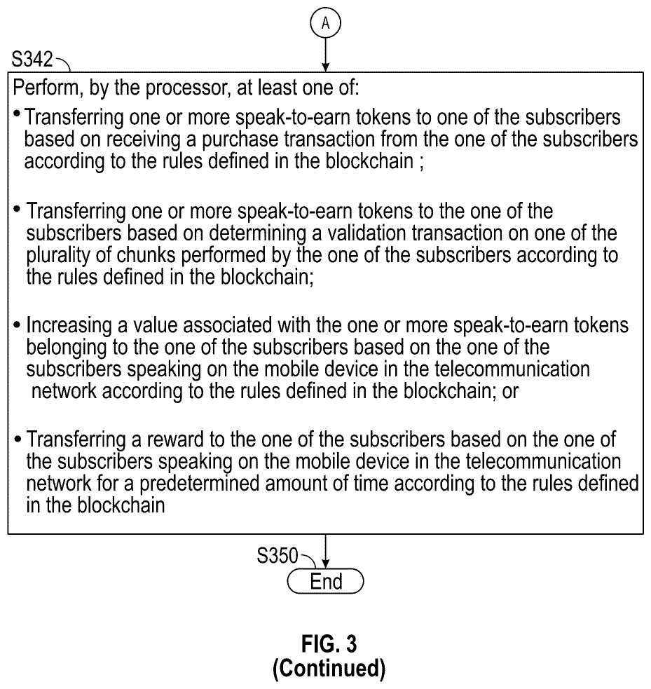

FIG. 3 is a flowchart 300 of a method for creating Speak-To-Earn Tokens according to at least one embodiment.

Instructions for creating Speak-To-Earn Tokens according to at least one embodiment are stored on non-transitory, computer-readable storage medium. In FIG. 3, process starts S302 and a processor receives a selection of a Proof Of Stake consensus mechanism for Speak-To-Earn Tokens, wherein the Speak-To-Earn Tokens include a value based on a measurement of speaking by a user using a mobile device to another user in a telecommunication network S310. In the crypto environment, there are two main consensus mechanisms, POW (Proof Of Work) and POS (Proof Of Stake). In at least one embodiment, POS is used.

POS is a much greener alternative to the power-hungry POW model. POS relies on a probabilistic model for selecting validators where the probability of a validator getting a block to solve is directly proportional to the amount of staked value locked up in the blockchain network. The staked value is held as collateral which can be seized if any wrongdoing was seen on the part of the validator. The underlying math puzzle is similar to that employed in POW. However, the complexity of the problem is significantly reduced.

The processor receives selection of a blockchain platform for the Speak-To-Earn Tokens, the blockchain platform including a NEAR protocol network for implementing sharding to split the blockchain into a plurality of chunks, wherein each chunk of the plurality of chunks is separately verifiable S314. In at least one embodiment, a NEAR protocol network is used. The NEAR protocol supports java scripts language as well, and the NEAR Protocol is well-known for its ecosystem, which provides an environment for building decentralized applications. Using this protocol, developers are able to host serverless apps and smart contracts and benefit from an ecosystem of reusable smart contracts.

The processor receives input for designing nodes for the Speak-To-Earn Tokens S318. Once blockchain platform has been selected, nodes are able to be created according to functionality and workings. A node is a program that validates transactions for efficiency and security. Nodes are connected via the internet to the NEAR platform, and represent the infrastructure of a blockchain and are responsible for creating, storing, and spreading the blocks. The goal of nodes is to complete specific tasks, such as verifying transactions or storing data. Based on the subscriptions of mobile users, nodes are able to be added horizontally. An operating system is selected for the nodes, such as Windows or Ubuntu. Finally, another aspect of node design is hardware specifications, such as processor speed, GPU, disk space, memory, etc. Nodes are able to be designed with different features, such as set permissions to be either private or public, choose between on-premises or cloud hosting, select the hardware details, such as the processors, memory, and disk size, and selection of a base operating system (e.g., Ubuntu, Windows, Red Hat, Debian, Fedora, etc.)

The processor establishes a blockchain for the Speak-To-Earn Tokens based on the consensus mechanism, the blockchain platform, and the nodes S322. The blockchain architecture includes a series of parameters that are set before the launch. Examples of parameters for the blockchain architecture includes block sizes, rewards for validating blocks, etc. Parameters are also able to be used to define who can access, create, and validate new blocks, to define the look of the blockchain address, to define the format of the keys, to set the rules for asset issuance, to create a management system for private key protection and storage, to decide on the number of digital signatures for blockchain used to verify the transactions, and to create block signatures.

The processor integrates an Application Programming Interface (API) for the Speak-To-Earn Tokens S326. The goal of API is to deliver data and establish a connection between programs and devices. Not every platform offers Application Programming Interfaces (APIs). However, in response to selection of a platform that does not offer pre-built APIs, there are many API providers available for blockchains.

A User Interface (UI) is implemented for the Speak-To-Earn Tokens by the processor S330. A good intuitive interface enables users to build accurate communication and adds value. At this stage of cryptocurrency development, a check to ensure servers are secure and compliant, and that external databases are of the most recent version (e.g. MySQL, MongoDB). The front-end and back-end programming is able to be executed with future upgrades in mind, including Web3 mobile phones. Applications are built as user interfaces that integrate blockchain networks and second layer protocols rather than traditional databases, such as used by Web3.

The design of a Speak-To-Earn Token User Interface is based on the backend of the network. Based on the consensus and blockchain platform, and design nodes, the Speak-To-Earn provider, e.g. a telecom provider, connects with mobile phone via the Speak-To-Earn Token User Interface and determines the value to give to the Speak-To-Earn Token of a subscriber based on a smart contract.

The processor legalizes the Speak-To-Earn Tokens S334. Cryptocurrency regulations help to monitor the emerging digital currencies and provide clearly defined rules for legalizing new cryptocurrency. Legalizing cryptocurrency is avoids legal problems.

The processor provisions the Speak-To-Earn Tokens for transfer to subscribers of the telecommunication network according to rules defined in the blockchain S338. The Speak-To-Earn Tokens are generated and stored by the service provider. Based upon transactions defined by the blockchain, the service provider manages unissued Speak-To-Earn Tokens. Transactions include a purchase of Speak-To-Earn Tokens by subscribers, a validation transaction by a subscriber, a subscriber speaking on a mobile phone in the network of the network (e.g., making a voice call), and receiving a reward based on a subscriber speaking on the mobile device in the telecommunication network for a predetermined amount of time.

The processor manages the Speak-To-Earn Tokens S352. The processor performs at least one of:
transferring one or more Speak-To-Earn Tokens to one of the subscribers based on receiving a purchase transaction from the one of the subscribers according to the rules defined in the blockchain;
transferring one or more Speak-To-Earn Tokens to one of the subscribers based on determining a validation transaction on one of the plurality of chunks performed by one of the subscribers according to the rules defined in the blockchain;
increasing a value associated with the one or more Speak-To-Earn Tokens belonging to one of the subscribers based on the one of the subscribers speaking on the mobile device in the telecommunication network according to the rules defined in the blockchain; or
transferring a reward to one of the subscribers based on the one of the subscribers speaking on the mobile device in the telecommunication network for a predetermined amount of time according to the rules defined in the blockchain.

The process then terminates S350.

As shown in FIG. 3, in at least one embodiment Speak-To-Earn Tokens are created. A processor receives a selection of a consensus mechanism for Speak-To-Earn Tokens, wherein the Speak-To-Earn Tokens include a value based on a measurement of speaking using a mobile device in a telecommunication network. The processor receives a selection of a blockchain platform for the Speak-To-Earn Tokens and receives input for designing nodes for the Speak-To-Earn Tokens. The processor establishes a blockchain for the Speak-To-Earn Tokens based on the consensus mechanism, the blockchain platform, and the nodes. The processor generates the Speak-To-Earn Tokens based on the blockchain, and provisions the Speak-To-Earn Tokens for transfer to subscribers of the telecommunication network according to rules defined in the blockchain.

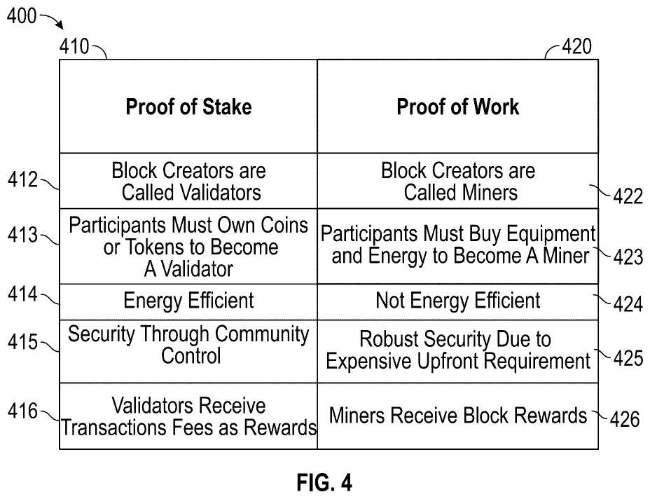

FIG. 4 is a comparison 400 of consensus mechanism to use for Speak-To-Earn Token according to at least one embodiment.

In FIG. 4, the two consensus mechanisms being compared are Proof of Stake (POS) 410 and Proof of Work (PoW) 420. A consensus mechanism in blockchain refers to the way changes to the blockchain are agreed upon. Because blockchains are a series of ledgers held within numerous servers, consensus mechanisms are used to confirm that any changes to the ledger are valid and void of any forms of corruption. Without a central authority having the final say on what transactions are valid, blockchain technology uses these decentralized consensus algorithms to reach such an agreement. There are many different consensus mechanisms, such as Directed Acyclic Graphs (DAGs), Proof of Authority (PoA), Proof of Capacity (PoC), Proof of Burn (PoB), Proof of Elapsed Time (PoET), etc. However, Proof of Stake (PoS) 410 and Proof of Work (PoW) 420 are the two major consensus mechanisms used to verify new transactions, add transactions to the blockchain, and to create new tokens.

In Proof of Stake (POS) 410, block creators are called validators 412. A validator checks transactions, verifies activity, votes on outcomes, and maintains records. Under PoW 420, block creators are called miners 422. Miners work to solve for the hash, a cryptographic number, to verify transactions. In return for solving the hash, they are rewarded with a coin.

Under PoS 410, to “buy into” the position of becoming a block creator, a participant has to only own enough coins or tokens to become a validator 413. For PoW 420, miners invest in processing equipment and incur hefty energy charges to power the machines attempting to solve the computations 423.

For PoW 420, the equipment and energy costs mechanisms are expensive 424, limiting access to mining and strengthening the security of the blockchain. For POS 410, the amount of processing power used to validate block information and transactions is reduced 414. The mechanism also lowers network congestion and removes the rewards-based incentive found in PoW 420.

In PoS 410, security is provided through community control 415. Long touted as a threat for cryptocurrency fans, the 51% attack is a concern when PoS 410 is used, but there is doubt such an attack will occur. Under PoW, a 51% attack is when an entity controls more than 50% of the miners in a network and uses that majority to alter the blockchain. In PoS 410, a group or individual owns 51% of the staked cryptocurrency. In response to a 51% attack occurring, honest validators in the network could vote to disregard the altered blockchain and burn the offender(s) staked cryptocurrency. This incentivizes validators to act in good faith to benefit the cryptocurrency and the network. PoS mechanisms 410 include extra security features that add to the inherent security behind blockchains. In PoW 420, security is robust due to the expensive upfront cost 425.

In PoS 410, validators hold and stake tokens for the privilege of earning transaction fees as rewards 416. In PoW mechanisms, miners solve cryptographic puzzles, wherein miners are incentivized to search for blocks via block rewards and transaction fees 426. Block rewards are a fixed reward paid when a block is created, and transaction fees are paid by users to have their transactions processed and included in the blockchain.

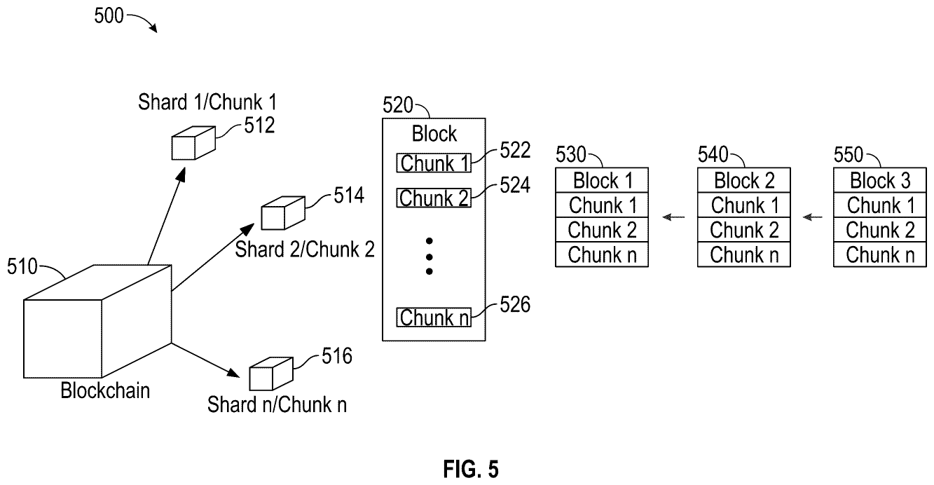

FIG. 5 illustrates NEAR sharding 500 according to at least one embodiment.

In FIG. 5, Block 510 represents the blockchain. The Blockchain 510 is split using a NEAR sharding process so that the Blockchain 510 is separated into components called shards, e.g., Shard 1/Chunk 1 512, Shard/Chunk 2 514, Shard/Chunk n 516. Each shard submits its own segment of each block, called a “chunk.”

In comparison a non-sharded blockchain is like an assembly line where at each step a small task is performed, and the product is incrementally moved along to its final state. Thus, in a non-sharded blockchain, transactions are sent, verified, processed, and added to one long chained database by either miners or validators. Whether the blockchain involved is Proof-of-Work or Proof-of-Stake, the problem is that only so much can be done before the process slows down. Every miner or validator works on the same group of transactions, processing one block at a time. Consequently, the more used the blockchain in question becomes, the slower it becomes.

NEAR sharding 500 attempts to address this problem by splitting the blockchain 510 into non-overlapping chunks to provide horizontal scaling. Instead of depending on miners or validators to process each block, one at-a-time, a sharded network is one that is purposefully broken into several chains or “shards,” to which subsets of validators are assigned. These subsets, in turn, process small groups of transactions instead of doing so altogether as in traditional PoS networks. NEAR protocol attempts to swiftly deliver a fully sharded network, but is also designed to exponentially increase the network of validators.

Shard 512 includes its own data that is separate from other shards, e.g., Shards 514, 516. Each node in a network only performs a subset of the total work. Transactions from Shard 1/Chunk 1 512, Shard/Chunk 2 514, Shard/Chunk n 516 combine to form a block 510.

Each chunk 512, 514, 516 is managed by a group of validators, who together take care of storage and compute resources used to process transactions related to that chunk. Each participant of the network only maintains the state that corresponds to the shards that they validate transactions for. A list of the transactions in the block is split into physical chunks, one chunk per shard.

Once a block producer produces a chunk, the producer creates an erasure coded version of the chunk, e.g., 522, 524, 526. Erasure Codes are used to recover the full block even if only some part of the block is available. Each part of the erasure coded chunk is sent to a designated block producer via a onepart message. Block producers and validators do not process blocks until they have onepart messages for each chunk included in the block. Thus, by the time any particular participant applies a block, the onepart messages that correspond to chunks in that block are obtained. Thus, each participants has the incoming receipts for the shards that the participant maintains state for as their destination.

A validator is assigned the responsibility to assemble Block 520 from Chunks 522, 524, 526 resulting from the Shards 512, 514, 516. Each shard assigns its own validator to produce its own chunk. Validators are selected using a secure randomized process.

In FIG. 5, Block 1 530 has no predecessor. Block 2 540 includes a hash of Block 1 530. While Block 3 550 includes the hash of Block 2 540. Each block, Block 1 530, Block 2 540, Block 3 550, logically contains the transactions for the shards, and changes the state of the shards. Physically, however, no participant downloads the full state or the full logical block 510. Instead, each participant of the network only maintains the state that corresponds to the shards that they validate transactions for, and the list of the transactions in the block is split into physical chunks, one chunk per shard.

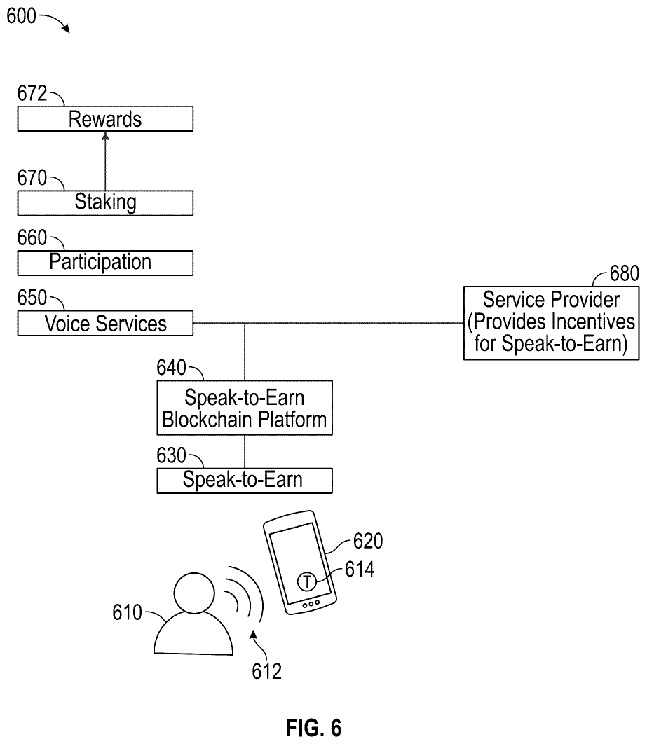

FIG. 6 illustrates operation of a Speak-To-Earn Token System 600 according to at least one embodiment.

In FIG. 6, User 610 uses Mobile Phone 620 to receive Speech 612. For example, Speech 612 includes making a call using a mobile network. Phone 620 is connected to Speak-To-Earn Platform 630. Speak-To-Earn Platform 630 provides the underlying structure for processing received Speech 612 as it applies to Speak-To-Earn Blockchain 640. Speak-To-Earn Blockchain 640 includes a list of records, called blocks, that are securely linked together using cryptography, wherein the records reflect changes based on Mobile Phone 620 receiving Speech 612 from User 610. Speak-To-Earn Platform 630 thus interfaces with Speak-To-Earn Blockchain 640 to modify records associated with the received Speech 612. Speak-To-Earn Blockchain 640 is configured to provide Rewards 672 to User 610 via Speak-To-Earn Token 614 for using Mobile Phones 620 to use Voice Services 650 of the service provider.

Participation 660 reflects a User 610 joining Speak-To-Earn Blockchain 640 and conducting qualifying transactions, i.e., providing Speech 612 to Mobile Phone 620. Staking 670 represents User 610 buying into the position of becoming a block creator, e.g., purchasing a Speak-To-Earn Token 614.

The telecommunications provider is the only creator and supplier of the Speak-To-Earn Token 614. In the telecommunications industry, there are no specific cryptocurrencies for leveraging the network of telecommunications provider, i.e., Service Provider 680. User 610 is able to use the Speak-To-Earn Token 614 to earn value. Because of the widespread use of mobile phones, a large number of Speak-To-Earn Tokens 614 are likely to be used, e.g., hundreds of millions to tens of billions. Accordingly, the market capitalization of ten billion is possible with ten billion tokens reaching a value of one dollar.

The Speak-To-Earn Token 614 is able to be used for subscriber packages, rewards, data plans, etc. Users 610 (e.g., subscribers) are able to use the Speak-To-Earn Token 614 for each of their Mobile Phones 630.

In telecommunications networks, there are incoming calls and outgoing calls. Every subscriber has an identifier and the Mobile Phones 620 include other identifiers. For example, IMSI (International Mobile Subscriber Identity) is a unique number associated with a SIM card. IMSI does not change, even in response to a user swapping a SIM card into a different phone. IMEI (International Mobile Equipment Identity) is a unique number identifying a particular phone. The IMEI changes whenever a different phone is used. ESN (Equipment Serial Number) uniquely identifies equipment and is embedded electronically by the manufacturer. Mobile Subscriber ID (MSID) (also referred to as Mobile Identification Number (MIN)) is a number to identify mobile subscribers within a mobile carrier network. The MSIN is part of the International Mobile Subscriber Identity (IMSI) number. These identifiers allow User 610 to be identified within a network by the telecom provider 680.

In the Speak-To-Earn Blockchain Platform 640, these identifiers are able to be tracked and used to determine the type and amount of usage of the network. Based on the calculation of the amount of speaking, the Speak-To-Earn Token 614 is available as a reward to User 610 in an application running on the Mobile Phone 620. User 610 is able to use the Speak-To-Earn Token 614 or is able to sell the Speak-To-Earn Token 614 in the marketplace. The value of the Speak-To-Earn Token 614 is controlled from the backend of the network by Service Provider 680. The value of the Speak-To-Earn Token 614 is based on a smart contract associated with Speak-To-Earn Blockchain Platform 640 that the telecom provider 680 references to generate the Speak-To-Earn Token 614.

Service Provider 680 are also capable of providing rewards or incentives to User 610 based on User 610 providing Speech 612 to Mobile Phone 620 that is tracked via Speak-To-Earn Token 614. For example, based on Speak-To-Earn Token 614 reflecting value, Service Provider 680 is capable of providing time credits, non-speech-related incentives (e.g., an increase in data allotment), discounts, etc. For example, in response to users recharging their mobile package with Speak-To-Earn Token 614, the user is granted by Service Provider 680 an extra 10 GB data for free. Such data reward is capable of being limited to a predetermined number of users, e.g., first 1 million users.

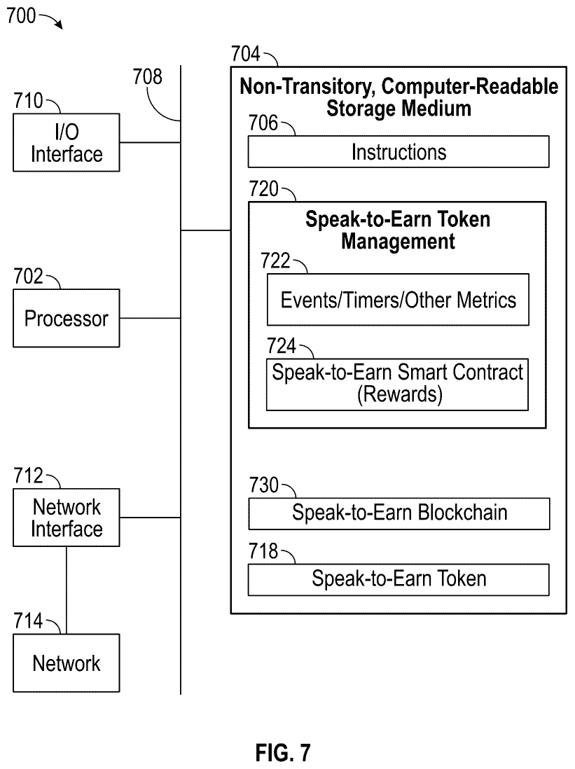

FIG. 7 is a high-level functional block diagram of a processor-based speak-to-earn system 700 for according to at least one embodiment.

In at least one embodiment, processing circuitry 700 provides a Speak-To-Earn Token 718 for earning value based a user speaking on a mobile device to another user in the mobile network. Processing circuitry 700 creates the Speak-To-Earn Token 718 using processor 702. Processing circuitry 700 also includes a non-transitory, computer-readable storage medium 704 that is used to create the Speak-To-Earn Token 718. Storage medium 704, amongst other things, is encoded with, i.e., stores, instructions 706, i.e., computer program code that are executed by processor 702 causes processor 702 to perform operations for creating the Speak-To-Earn Token 718. Execution of instructions 706 by processor 702 represents (at least in part) an application which implements at least a portion of the methods described herein in accordance with one or more embodiments (hereinafter, the noted processes and/or methods).

Processor 702 is electrically coupled to computer-readable storage medium 704 via a bus 708. Processor 702 is electrically coupled to an Input/output (I/O) interface 710 by bus 708. A network interface 712 is also electrically connected to processor 702 via bus 708. Network interface 712 is connected to a network 714, so that processor 702 and computer-readable storage medium 704 connect to external elements via network 714. Processor 702 is configured to execute instructions 706 encoded in computer-readable storage medium 704 to cause processing circuitry 700 to be usable for performing at least a portion of the processes and/or methods. In one or more embodiments, processor 702 is a Central Processing Unit (CPU), a multi-processor, a distributed processing system, an Application Specific Integrated Circuit (ASIC), and/or a suitable processing unit.

Processing circuitry 700 includes I/O interface 710. I/O interface 710 is coupled to external circuitry. In one or more embodiments, I/O interface 710 includes a keyboard, keypad, mouse, trackball, trackpad, touchscreen, and/or cursor direction keys for communicating information and commands to processor 702.

Processing circuitry 700 also includes network interface 712 coupled to processor 702. Network interface 712 allows processing circuitry 700 to communicate with network 714, to which one or more other computer systems are connected. Network interface 712 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 700 is configured to receive information through I/O interface 710. The information received through I/O interface 710 includes one or more of instructions, data, design rules, libraries of cells, and/or other parameters for processing by processor 702. The information is transferred to processor 702 via bus 708.

In one or more embodiments, one or more non-transitory computer-readable storage media 704 having stored thereon instructions (in compressed or uncompressed form) that may be used to program a computer, processor, or other electronic device) to perform processes or methods described herein. The one or more non-transitory computer-readable storage media 704 include one or more of an electronic storage medium, a magnetic storage medium, an optical storage medium, a quantum storage medium, or the like.

For example, the computer-readable storage media may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more non-transitory computer-readable storage media 704 includes a Compact Disk-Read Only Memory (CD-ROM), a Compact Disk-Read/Write (CD-R/W), and/or a Digital Video Disc (DVD).

In one or more embodiments, Non-Transitory, Computer-Readable Storage Medium 706 stores computer program code 706 configured to cause Processor 702 to perform at least a portion of the processes and/or methods for creating the Speak-To-Earn Token 718. In one or more embodiments, Non-Transitory, Computer-Readable Storage Medium 706 also stores information, such as algorithm which facilitates performing at least a portion of the processes and/or methods for creating the Speak-To-Earn Token 718. Non-Transitory, Computer-Readable Storage Medium 706 stores information for providing Speak-To-Earn Token Management 720 including monitoring speech on the mobile network by the user through Events/Timers 722, determining Rewards according to Speak-To-Earn Smart Contract 724, and managing the Speak-To-Earn Blockchain 730. In at least one embodiment, Processor 702 executes Instructions 708 stored on the one or more Non-Transitory, Computer-Readable Storage Medium 706 to receive a selection of a proof of stake consensus mechanism for Speak-To-Earn Tokens, wherein the Speak-To-Earn Tokens include a value based on a measurement of speaking using a mobile device in a telecommunication network, receive selection of a blockchain platform for the Speak-To-Earn Tokens, the blockchain platform including a near protocol network for implementing sharding to split the blockchain into a plurality of chunks, wherein each chunk of the plurality of chunks is separately verifiable, receive input for designing nodes for the Speak-To-Earn Tokens, establish a blockchain for the Speak-To-Earn Tokens based on the consensus mechanism, the blockchain platform, and the nodes, integrate an API for the Speak-To-Earn Tokens, and provision, by the processor, the Speak-To-Earn Tokens for transfer to subscribers of the telecommunication network according to rules defined in the blockchain, including generating and storing the Speak-To-Earn Tokens. The Processor 402 further executes Instructions 708 stored on the one or more Non-Transitory, Computer-Readable Storage Medium 706 to perform at least one of transferring one or more Speak-To-Earn Tokens to one of the subscribers based on receiving a purchase transaction from the one of the subscribers according to the rules defined in the blockchain, transferring one or more Speak-To-Earn Tokens to the one of the subscribers based on determining a validation transaction on one of the plurality of chunks performed by the one of the subscribers according to the rules defined in the blockchain, increasing a value associated with the one or more Speak-To-Earn Tokens belonging to the one of the subscribers based on the one of the subscribers speaking on the mobile device in the telecommunication network according to the rules defined in the blockchain, or transferring a reward to the one of the subscribers based on the one of the subscribers speaking on the mobile device in the telecommunication network for a predetermined amount of time according to the rules defined in the blockchain.

Accordingly, in at least one embodiment, Processor 702 executes Instructions 708 stored on the one or more Non-Transitory, Computer-Readable Storage Medium 706 to create the Speak-To-Earn Token 718, monitor speech on the mobile network by the user through Events/Timers 722, determine Rewards 724, and manage the Speak-To-Earn Blockchain 730.

A predetermined threshold is able to be used to determine a value to credit the Speak-To-Earn Token 718 of a subscriber. The value of the Speak-To-Earn Token 718 is controlled from the backend of the network. The value is based on a Smart Contract 724 that the telecom provider references to generate the Speak-To-Earn Token 718. For example, a predetermined value is able to be awarded to a subscriber for speaking for more than 20 minutes based on Timers/Metrics 722. Other metrics than time are also capable of being used, e.g., data consumed, text sent, etc. More revenue is generated for the provider of the Speak-To-Earn Token 718 as the subscriber speaks more. Metrics 722 are also capable of being set or changed dynamically. The maximum supply of Speak-To-Earn Token 718 is also able to be set dynamically.

Embodiments described herein provide a method that provides one or more advantages. The Speak-To-Earn Token 718 provides an opportunity significant share in the cryptocurrency market. In response to issuance of 10 billion Speak-To-Earn Token 718 in the market, and the value of the Speak-To-Earn Token 718 reaching $1 dollar, then the Speak-To-Earn Token 718 results in a $10 billion dollar market capitalization. In such a large market provided by the telecom industry, the Speak-To-Earn Token 718 is capable of becoming a top 10 cryptocurrency. Also, the Speak-To-Earn Token 718 is able to increase subscribers in the mobile network.

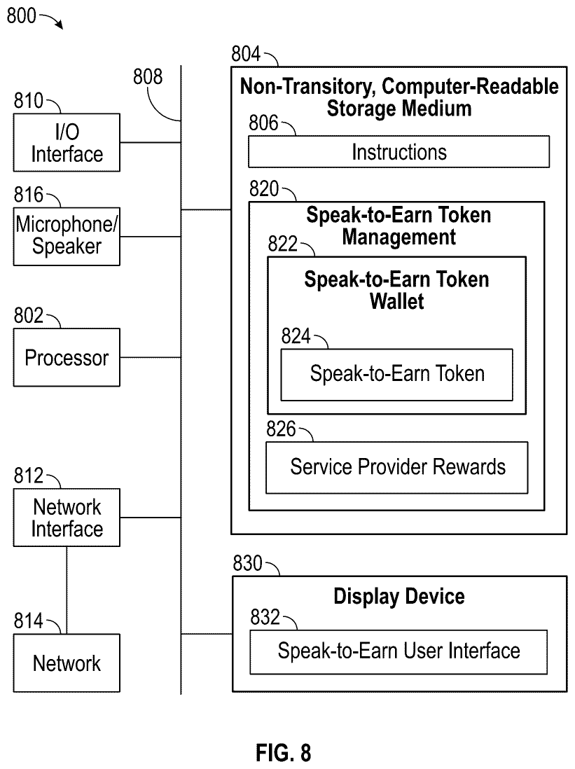

FIG. 8 is a high-level functional block diagram of a processor-based system 800 according to at least one embodiment.

In at least one embodiment, processing circuitry 800 provides Speak-To-Earn Token Management 820, where Speak-To-Earn Token 824 stored in Speak-To-Earn Token Wallet 822 is used to earn value by providing speech via Microphone/Speaker 816. Processing circuitry 800 also includes a non-transitory, computer-readable storage medium 804 that is used to earn value by providing speech via Microphone/Speaker 816 and using Speak-To-Earn Token 824 stored in Speak-To-Earn Token Wallet 822. Storage medium 804, amongst other things, is encoded with, i.e., stores, instructions 806, i.e., computer program code that are executed by processor 802 causes processor 802 to perform operations for earning value by providing speech via Microphone/Speaker 816 and using Speak-To-Earn Token 824 stored in Speak-To-Earn Token Wallet 822. Execution of instructions 806 by processor 802 represents (at least in part) an application which implements at least a portion of the methods described herein in accordance with one or more embodiments (hereinafter, the noted processes and/or methods). Execution of instructions 806 by processor 802 enables the user to receive Service Provider Rewards 826 via Network 814.

Processor 802 is electrically coupled to computer-readable storage medium 804 via a bus 808. Processor 802 is electrically coupled to an Input/output (I/O) interface 810 by bus 808. A network interface 812 is also electrically connected to processor 802 via bus 808. Network interface 812 is connected to a network 814, so that processor 802 and computer-readable storage medium 804 connect to external elements via network 814. Processor 802 is configured to execute instructions 806 encoded in computer-readable storage medium 804 to cause processing circuitry 800 to be usable for performing at least a portion of the processes and/or methods. In one or more embodiments, processor 802 is a Central Processing Unit (CPU), a multi-processor, a distributed processing system, an Application Specific Integrated Circuit (ASIC), and/or a suitable processing unit.

Processing circuitry 800 includes I/O interface 810. I/O interface 810 is coupled to external circuitry. In one or more embodiments, I/O interface 810 includes a keyboard, keypad, mouse, trackball, trackpad, touchscreen, and/or cursor direction keys for communicating information and commands to processor 802.

Processing circuitry 800 also includes network interface 812 coupled to processor 802. Network interface 812 allows processing circuitry 800 to communicate with network 814, to which one or more other computer systems are connected. Network interface 812 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 864.

Processing circuitry 800 is configured to receive information through I/O interface 810. The information received through I/O interface 810 includes one or more of instructions, data, design rules, libraries of cells, and/or other parameters for processing by processor 802. The information is transferred to processor 802 via bus 808. In one or more embodiments, one or more non-transitory computer-readable storage media 804 having stored thereon instructions (in compressed or uncompressed form) that may be used to program a computer, processor, or other electronic device) to perform processes or methods described herein. The one or more non-transitory computer-readable storage media 804 include one or more of an electronic storage medium, a magnetic storage medium, an optical storage medium, a quantum storage medium, or the like.

For example, the computer-readable storage media may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more non-transitory computer-readable storage media 804 includes a Compact Disk-Read Only Memory (CD-ROM), a Compact Disk-Read/Write (CD-R/W), and/or a Digital Video Disc (DVD).

In one or more embodiments, Non-Transitory, Computer-Readable Storage Medium 806 stores computer program code 806 configured to cause Processor 802 to perform at least a portion of the processes and/or methods to earn value by providing speech via Microphone/Speaker 816 and using Speak-To-Earn Token 824 stored in Speak-To-Earn Token Wallet 822.

In one or more embodiments, Non-Transitory, Computer-Readable Storage Medium 806 also stores information, such as algorithm which facilitates performing at least a portion of the processes and/or methods for earning value by providing speech via Microphone/Speaker 816 and using Speak-To-Earn Token 824 stored in Speak-To-Earn Token Wallet 822. Accordingly, in at least one embodiment, Processor 802 executes Instructions 808 stored on the one or more Non-Transitory, Computer-Readable Storage Medium 806 to earn value by providing speech via Microphone/Speaker 816 and using Speak-To-Earn Token 824 stored in Speak-To-Earn Token Wallet 822. Processor 802 implements a Speak-To-Earn User Interface 832 on Display Device 830 to control usage of Speak-To-Earn Token 824 to earn value by providing speech via Microphone/Speaker 816 and using Speak-To-Earn Token 824 stored in Speak-To-Earn Token Wallet 822, and to review the value of Speak-To-Earn Token 824.

Embodiments described herein provide a method that provides one or more advantages. For example, Speak-To-Earn User Interface 832 on Display Device 830 is used to control usage of Speak-To-Earn Token 824 to earn value by providing speech via Microphone/Speaker 816, and to review the value of Speak-To-Earn Token 824. The user is also able to receive and use Service Provider Rewards 826. For example, in response to users recharging their mobile package with Speak-To-Earn Token 824, then the user is granted an extra 10 GB data for free. Such data reward is capable of being limited to a predetermined number of users, e.g., first 1 million users.

In a method according to at least one embodiment, a method for creating a Speak-To-Earn Token includes receiving, at a processor, a selection of a consensus mechanism for Speak-To-Earn Tokens, wherein the Speak-To-Earn Tokens include a value based on a measurement of speaking using a mobile device in a telecommunication network, receiving, at the processor, a selection of a blockchain platform for the Speak-To-Earn Tokens, receiving, at the processor, input for designing nodes for the Speak-To-Earn Tokens, establishing, by the processor, a blockchain for the Speak-To-Earn Tokens based on the consensus mechanism, the blockchain platform, and the nodes, generating, by the processor, the Speak-To-Earn Tokens based on the blockchain, and provisioning, by the processor, the Speak-To-Earn Tokens for transfer to subscribers of the telecommunication network according to rules defined in the blockchain.

In a method according to at least one embodiment, the method further includes integrating, by the processor, an application programming interface (API) for the Speak-To-Earn Tokens, and developing a user interface (UI) for the Speak-To-Earn Tokens.

In a method according to at least one embodiment, the method further includes legalizing the Speak-To-Earn Tokens.

In a method according to at least one embodiment, the receiving, at the processor, the selection of a consensus mechanism for the Speak-To-Earn Tokens further includes receiving a selection of a Proof Of Stake consensus mechanism for the Speak-To-Earn Tokens.

In a method according to at least one embodiment, the receiving, at the processor, the selection of the blockchain platform for the Speak-To-Earn Tokens includes receiving a selection of a NEAR protocol network.

In a method according to at least one embodiment, the receiving the selection of the NEAR protocol network includes implementing sharding to split the blockchain into a plurality of chunks, wherein each chunk of the plurality of chunks is separately verifiable.

In a method according to at least one embodiment, the method further includes performing, by the processor, at least one of transferring one or more Speak-To-Earn Tokens to one of the subscribers based on receiving a purchase transaction from the one of the subscribers according to the rules defined in the blockchain, transferring one or more Speak-To-Earn Tokens to the one of the subscribers based on determining a validation transaction on one of the plurality of chunks performed by the one of the subscribers according to the rules defined in the blockchain, increasing a value associated with the one or more Speak-To-Earn Tokens belonging to the one of the subscribers based on the one of the subscribers speaking on the mobile device in the telecommunication network according to the rules defined in the blockchain, or transferring a reward to the one of the subscribers based on the one of the subscribers speaking on the mobile device in the telecommunication network for a predetermined amount of time according to the rules defined in the blockchain.

In at least one embodiment, a system for creating a Speak-To-Earn Token includes a memory storing computer-readable instructions, and a processor connected to the memory, wherein the processor is configured to execute the computer-readable instructions to receive selection of a consensus mechanism for Speak-To-Earn Tokens, wherein the Speak-To-Earn Tokens include a value based on a measurement of speaking using a mobile device in a telecommunication network, receive selection of a blockchain platform for the Speak-To-Earn Tokens, receive input for designing nodes for the Speak-To-Earn Tokens, establish a blockchain for the Speak-To-Earn Tokens based on the consensus mechanism, the blockchain platform, and the nodes, generate the Speak-To-Earn Tokens based on the blockchain, and provision the Speak-To-Earn Tokens for transfer to subscribers of the telecommunication network according to rules defined in the blockchain.

In a system according to at least one embodiment, the processor is further configured to integrate an application programming interface (API) for the Speak-To-Earn Tokens, and receive input for developing a user interface (UI) for the Speak-To-Earn Tokens.

In a system according to at least one embodiment, the processor is further configured to legalize the Speak-To-Earn Tokens.

In a system according to at least one embodiment, the processor is further configured to receive the selection of the consensus mechanism for the Speak-To-Earn Tokens by receiving selection of a Proof Of Stake consensus mechanism for the Speak-To-Earn Tokens.

In a system according to at least one embodiment, the processor is further configured to receive the selection of the blockchain platform for the Speak-To-Earn Tokens by receiving a selection of a NEAR protocol network.

In a system according to at least one embodiment, the processor is further configured to implement sharding according to a received selection of the NEAR protocol network to split the blockchain into a plurality of chunks, wherein each chunk of the plurality of chunks is separately verifiable.

In a system according to at least one embodiment, the processor is further configured to perform at least one of transferring one or more Speak-To-Earn Tokens to one of the subscribers based on receiving a purchase transaction from the one of the subscribers according to the rules defined in the blockchain, transferring one or more Speak-To-Earn Tokens to the one of the subscribers based on determining a validation transaction on one of the plurality of chunks performed by the one of the subscribers according to the rules defined in the blockchain, increasing a value associated with the one or more Speak-To-Earn Tokens belonging to the one of the subscribers based on the one of the subscribers speaking on the mobile device in the telecommunication network according to the rules defined in the blockchain, or transferring a reward to the one of the subscribers based on the one of the subscribers speaking on the mobile device in the telecommunication network for a predetermined amount of time according to the rules defined in the blockchain.

In at least one embodiment, a non-transitory computer-readable media having computer-readable instructions stored thereon, which when executed by a processor causes the processor to perform operations including receiving a selection of a consensus mechanism for Speak-To-Earn Tokens, wherein the Speak-To-Earn Tokens include a value based on a measurement of speaking using a mobile device in a telecommunication network, receiving, at the processor, a selection of a blockchain platform for the Speak-To-Earn Tokens, receiving input for designing nodes for the Speak-To-Earn Tokens, establishing a blockchain for the Speak-To-Earn Tokens based on the consensus mechanism, the blockchain platform, and the nodes, generating the Speak-To-Earn Tokens based on the blockchain, and provisioning the Speak-To-Earn Tokens for transfer to subscribers of the telecommunication network according to rules defined in the blockchain.

In a non-transitory computer-readable media according to at least one embodiment, the computer-readable instructions, when executed by the processor cause the processor to perform further operations including integrating an application programming interface (API) for the Speak-To-Earn Tokens, and developing a user interface (UI) for the Speak-To-Earn Tokens.

In a non-transitory computer-readable media according to at least one embodiment, the computer-readable instructions, when executed by the processor cause the processor to perform further operations including legalizing the Speak-To-Earn Tokens.

In a non-transitory computer-readable media according to at least one embodiment, the receiving the selection of a consensus mechanism for the Speak-To-Earn Tokens further includes comprises receiving a selection of a Proof Of Stake consensus mechanism for the Speak-To-Earn Tokens.

In a non-transitory computer-readable media according to at least one embodiment, the receiving the selection of the blockchain platform for the Speak-To-Earn Token includes receiving a selection of a NEAR protocol network, wherein the receiving the selection of the NEAR protocol network includes implementing sharding to split the blockchain into a plurality of chunks, wherein each chunk of the plurality of chunks is separately verifiable.

In a non-transitory computer-readable media according to at least one embodiment, the computer-readable instructions, when executed by the processor cause the processor to perform further operations including performing at least one of transferring one or more Speak-To-Earn Tokens to one of the subscribers based on receiving a purchase transaction from the one of the subscribers according to the rules defined in the blockchain, transferring one or more Speak-To-Earn Tokens to the one of the subscribers based on determining a validation transaction on one of the plurality of chunks performed by the one of the subscribers according to the rules defined in the blockchain, increasing a value associated with the one or more Speak-To-Earn Tokens belonging to the one of the subscribers based on the one of the subscribers speaking on the mobile device in the telecommunication network according to the rules defined in the blockchain, or transferring a reward to the one of the subscribers based on the one of the subscribers speaking on the mobile device in the telecommunication network for a predetermined amount of time according to the rules defined in the blockchain. Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method for creating a Speak-To-Earn Token, comprising:
receiving, at a processor, a selection of a consensus mechanism for Speak-To-Earn Tokens, wherein the Speak-To-Earn Tokens include a value based on a measurement of speaking using a mobile device in a telecommunication network;
receiving, at the processor, a selection of a blockchain platform for the Speak-To-Earn Tokens;
receiving, at the processor, input for designing nodes for the Speak-To-Earn Tokens;
establishing, by the processor, a blockchain for the Speak-To-Earn Tokens based on the consensus mechanism, the blockchain platform, and the nodes;
generating, by the processor, the Speak-To-Earn Tokens based on the blockchain; and
provisioning, by the processor, the Speak-To-Earn Tokens for transfer to subscribers of the telecommunication network according to rules defined in the blockchain.

2. The method of claim 1 further comprising:
integrating, by the processor, an application programming interface (API) for the Speak-To-Earn Tokens; and
implementing, by the processor, a user interface (UI) for the Speak-To-Earn Tokens.

3. The method of claim 1 further comprising legalizing the Speak-To-Earn Tokens.

4. The method of claim 1, wherein the receiving, at the processor, the selection of the consensus mechanism for the Speak-To-Earn Tokens further comprises receiving a selection of a Proof Of Stake consensus mechanism for the Speak-To-Earn Tokens.

5. The method of claim 1, wherein the receiving, at the processor, the selection of the blockchain platform for the Speak-To-Earn Tokens includes receiving a selection of a NEAR protocol network.

6. The method of claim 5, wherein the receiving the selection of the NEAR protocol network includes implementing sharding to split the blockchain into a plurality of chunks, wherein each chunk of the plurality of chunks is separately verifiable.

7. The method of claim 1 further comprising performing, by the processor, at least one of:
transferring one or more Speak-To-Earn Tokens to one of the subscribers based on receiving a purchase transaction from the one of the subscribers according to the rules defined in the blockchain;
transferring one or more Speak-To-Earn Tokens to the one of the subscribers based on determining a validation transaction on one of a plurality of chunks performed by the one of the subscribers according to the rules defined in the blockchain;
increasing the value associated with the one or more Speak-To-Earn Tokens belonging to the one of the subscribers based on the one of the subscribers speaking on the mobile device in the telecommunication network according to the rules defined in the blockchain; or
transferring a reward to the one of the subscribers based on the one of the subscribers speaking on the mobile device in the telecommunication network for a predetermined amount of time according to the rules defined in the blockchain.

8. A system for creating a Speak-To-Earn Token, comprising:
a memory storing computer-readable instructions; and
a processor connected to the memory, wherein the processor is configured to execute the computer-readable instructions to:
receive selection of a consensus mechanism for Speak-To-Earn Tokens, wherein the Speak-To-Earn Tokens include a value based on a measurement of speaking using a mobile device in a telecommunication network;
receive selection of a blockchain platform for the Speak-To-Earn Tokens;
receive input for designing nodes for the Speak-To-Earn Tokens;
establish a blockchain for the Speak-To-Earn Tokens based on the consensus mechanism, the blockchain platform, and the nodes;
generate the Speak-To-Earn Tokens based on the blockchain; and
provision the Speak-To-Earn Tokens for transfer to subscribers of the telecommunication network according to rules defined in the blockchain.

9. The system of claim 8, wherein the processor is further configured to integrate an application programming interface (API) for the Speak-To-Earn Tokens, and receive input for implementing a user interface (UI) for the Speak-To-Earn Tokens.

10. The system of claim 8, wherein the processor is further configured to legalize the Speak-To-Earn Tokens.

11. The system of claim 8, wherein the processor is further configured to receive the selection of the consensus mechanism for the Speak-To-Earn Tokens by receiving selection of a Proof Of Stake consensus mechanism for the Speak-To-Earn Tokens.

12. The system of claim 8, wherein the processor is further configured to receive the selection of the blockchain platform for the Speak-To-Earn Tokens by receiving a selection of a NEAR protocol network.

13. The system of claim 12, wherein the processor is further configured to implement sharding according to the selection of the NEAR protocol network to split the blockchain into a plurality of chunks, wherein each chunk of the plurality of chunks is separately verifiable.

14. The system of claim 8, wherein the processor is further configured to perform at least one of:
transferring one or more Speak-To-Earn Tokens to one of the subscribers based on receiving a purchase transaction from the one of the subscribers according to the rules defined in the blockchain;
transferring one or more Speak-To-Earn Tokens to the one of the subscribers based on determining a validation transaction on one of a plurality of chunks performed by the one of the subscribers according to the rules defined in the blockchain;
increasing the value associated with the one or more Speak-To-Earn Tokens belonging to the one of the subscribers based on the one of the subscribers speaking on the mobile device in the telecommunication network according to the rules defined in the blockchain; or
transferring a reward to the one of the subscribers based on the one of the subscribers speaking on the mobile device in the telecommunication network for a predetermined amount of time according to the rules defined in the blockchain.

15. A non-transitory computer-readable media having computer-readable instructions stored thereon, which when executed by a processor causes the processor to perform operations comprising:
receiving a selection of a consensus mechanism for Speak-To-Earn Tokens, wherein the Speak-To-Earn Tokens include a value based on a measurement of speaking using a mobile device in a telecommunication network;
receiving a selection of a blockchain platform for the Speak-To-Earn Tokens;
receiving input for designing nodes for the Speak-To-Earn Tokens;
establishing a blockchain for the Speak-To-Earn Tokens based on the consensus mechanism, the blockchain platform, and the nodes;
generating the Speak-To-Earn Tokens based on the blockchain; and
provisioning the Speak-To-Earn Tokens for transfer to subscribers of the telecommunication network according to rules defined in the blockchain.

16. The non-transitory computer-readable media of claim 15, further comprising:
integrating an application programming interface (API) for the Speak-To-Earn Tokens; and
implementing a user interface (UI) for the Speak-To-Earn Tokens.

17. The non-transitory computer-readable media of claim 15 further comprising legalizing the Speak-To-Earn Tokens.

18. The non-transitory computer-readable media of claim 15, wherein the receiving the selection of the consensus mechanism for the Speak-To-Earn Tokens further comprises receiving a selection of a Proof Of Stake consensus mechanism for the Speak-To-Earn Tokens.

19. The non-transitory computer-readable media of claim 15, wherein the receiving the selection of the blockchain platform for the Speak-To-Earn Token includes receiving a selection of a NEAR protocol network, wherein the receiving the selection of the NEAR protocol network includes implementing sharding to split the blockchain into a plurality of chunks, wherein each chunk of the plurality of chunks is separately verifiable.

20. The non-transitory computer-readable media of claim 15 further comprising performing at least one of:
transferring one or more Speak-To-Earn Tokens to one of the subscribers based on receiving a purchase transaction from the one of the subscribers according to the rules defined in the blockchain;
transferring one or more Speak-To-Earn Tokens to the one of the subscribers based on determining a validation transaction on one of a plurality of chunks performed by the one of the subscribers according to the rules defined in the blockchain;
increasing the value associated with the one or more Speak-To-Earn Tokens belonging to the one of the subscribers based on the one of the subscribers speaking on the mobile device in the telecommunication network according to the rules defined in the blockchain; or
transferring a reward to the one of the subscribers based on the one of the subscribers speaking on the mobile device in the telecommunication network for a predetermined amount of time according to the rules defined in the blockchain.
